(19) United States
(12) Patent Application Publication
(10) Pub. No.: US 2012/0059609 A1
(43) Pub. Date: Mar. 8, 2012

(54) SYSTEM FOR ELECTRIC ENERGY MANAGEMENT

(75) Inventors: Jung Hwan OH, Seoul (KR); Jae Seong Park, Daejeon (KR)

(73) Assignee: LSIS CO., LTD.

(21) Appl. No.: 13/215,080

(22) Filed: Aug. 22, 2011

(30) Foreign Application Priority Data
Sep. 3, 2010 (KR) 10-2010-0086738

(51) Int. Cl. G06F 19/00

(52) U.S. Cl. 702/62

(57) ABSTRACT

A system for electric energy management inspects admittances or impedances at several positions on the same power line, and determines the presence of electricity theft based on them. Particularly, each of the admittances or impedances is calculated based on information on an amount of electricity measured by each watt-hour meter. Since information on amounts of electricity respectively measured at an upper place and several lower places on the same power line have a certain correspondence relation, the calculated admittances or impedances also have a relation. For example, the admittance or impedance at the upper place is necessarily corresponds to the equivalent value of the admittances or impedance at the lower places. Thus, it is possible to precisely determine the presence of electricity theft by monitoring whether or not the difference value is within an acceptable range in consideration of an error of measuring the amount of electricity, or the like.

### CROSS-REFERENCE TO RELATED APPLICATION

This application claims the benefit of Korean Patent Application No. 10-2010-0086738 filed Sep. 3, 2010, the disclosure of which is hereby incorporated herein by reference in its entirety.

### BACKGROUND OF THE INVENTION

1. Field of the Invention

An aspect of the present invention relates to a system for electric energy management, and more particularly, to a system for electric energy management, which can monitor presence of occurrence of electricity theft based on information on the quantity of electricity measured by a plurality of watt-hour meters, and notify a manager of the presence of the occurrence of the electricity theft.

2. Description of the Related Art

It is an important issue to monitor and prevent electricity theft in relation to management of electric energy, and smart meters have recently required the function of monitoring and preventing the electricity theft.

If the electricity theft occurs, there is a serious risk that a safety accident such as an electric shock or fire may occur. More than anything else, an electric power company is directly affected by the economic loss.

Therefore, it is required to develop various methods for precisely and effectively monitoring the electricity theft. Particularly, inconvenience should not be caused to honest users that normally use electric energy in the process of monitoring the electricity theft.

### SUMMARY OF THE INVENTION

Embodiments of the present invention provide a system for electric energy management, which can calculate admittance or impedance at each place based on an amount of electricity measured by each watt-hour meter, and precisely determine the presence of electricity theft using the calculated admittances or impedances.

According to an aspect of the present invention, there is provided a system for electric energy management, the system including: a first watt-hour meter installed at an upper place on an electric power line, which is close to a power source, so as to measure an amount of electricity supplied to a load with respect to a position at which the first watt-hour meter is installed and calculate a first admittance based on the measured amount of electricity; a plurality of second watt-hour meters installed at a lower place on the same electric power line as the first watt-hour meter so as to measure an amount of electricity supplied to a load with respect to a position at which each of the second watt-hour meters is installed and calculates second admittances based on the respective measured amounts of electricity; and a remote server configured to collect information on the amounts of electricity from the first and second watt-hour meters.

The remote server may collect the information on the admittances respectively calculated by the first and second watt-hour meters, compare the first admittance with the total sum of the second admittances, and determine the presence of electricity theft based on a degree to which the difference between the first admittance and the total sum of the second admittances is deviated from an acceptable range.

According to another aspect of the present invention, there is provided a system for electric energy management, the system including: a first watt-hour meter installed at an upper place on an electric power line, which is close to a power source, so as to measure an amount of electricity supplied to a load; a plurality of second watt-hour meters installed at a lower place on the same electric power line as the first watt-hour meter; and a remote server configured to collect information on the amounts of electricity from the first and second watt-hour meters.

In some exemplary embodiments, the remote server may calculate a first admittance based on the information on the amount of electricity collected from the first watt-hour meter, calculate second admittances based on information on the amounts of electricity respectively collected from the second watt-hour meters, compare the calculated first admittance with the total sum of the calculated second admittances, and determine the presence of electricity theft based on a degree to which the difference between the first admittance and the total sum of the second admittances is deviated from an acceptable range.

In some exemplary embodiments, the admittance may be calculated based on information on amounts of electricity measured at the same time.

In some exemplary embodiments, the admittance may be calculated based on an accumulated value of amounts of electricity, an instantaneous value of amounts of electricity and a mean value of amounts of electricity for a certain period of time.

In some exemplary embodiments, the remote server may determine the presence of electricity theft based on a mean value of admittances for a certain period of time.

In some exemplary embodiments, the remote server may determine the presence of electricity theft based on whether or not the difference value between the first admittance and the total sum of the second admittances is a previously set limit value or more.

In some exemplary embodiments, the remote server may determine the presence of electricity theft based on the fluctuation in the difference value between the first admittance and the total sum of the second admittances.

According to still another aspect of the present invention, there is provided a system for electric energy management, the system including: a first watt-hour meter installed at an upper place on an electric power line, which is close to a power source, so as to measure an amount of electricity supplied to a load with respect to a position at which the first watt-hour meter is installed and calculate a first impedance based on the measured amount of electricity; a plurality of second watt-hour meters installed at a lower place on the same electric power line as the first watt-hour meter so as to measure an amount of electricity supplied to a load with respect to a position at which each of the second watt-hour meters is installed and calculates second impedances based on the respective measured amounts of electricity; and a remote server configured to collect information on the amounts of electricity from the first and second watt-hour meters.

In some exemplary embodiments, the remote server may collect the information on the impedances respectively calculated by the first and second watt-hour meters, compare the first impedance with the equivalent of the second impedances, and determine the presence of electricity theft based on a degree to which the difference between the first impedance and the equivalent value of the second impedances is deviated from an acceptable range.

According to still another aspect of the present invention, there is provided a system for electric energy management, the system including: a first watt-hour meter installed at an upper place on an electric power line, which is close to a power source, so as to measure an amount of electricity supplied to a load; a plurality of second watt-hour meters installed at a lower place on the same electric power line as the first watt-hour meter; and a remote server configured to collect information on the amounts of electricity from the first and second watt-hour meters.

In some exemplary embodiments, the remote server may calculate a first impedance based on the information on the amount of electricity collected from the first watt-hour meter, calculate second impedances based on information on the amounts of electricity respectively collected from the second watt-hour meters, compare the calculated first impedance with the equivalent value of the calculated second impedances, and determine the presence of electricity theft based on a degree to which the difference between the first impedance and the equivalent value of the second impedances is deviated from an acceptable range.

In some exemplary embodiments, the impedance may be calculated based on information on amounts of electricity measured at the same time.

In some exemplary embodiments, the impedance may be calculated based on an accumulated value of amounts of electricity, an instantaneous value of amounts of electricity and a mean value of amounts of electricity for a certain period of time.

In some exemplary embodiments, the remote server may determine the presence of electricity theft based on a mean value of impedances for a certain period of time.

In some exemplary embodiments, the remote server may determine the presence of electricity theft based on whether difference value between the first impedance and the equivalent value of the second impedances is a previously set limit value or more.

In some exemplary embodiments, the remote server may determine the presence of electricity theft based on the fluctuation in the difference value between the first impedance and the equivalent value of the second impedances.

In some exemplary embodiments, when it is determined that electricity theft has occurred, the remote server may notify a manager of the occurrence of the electricity theft. The remote server may periodically determine the presence of the electricity theft at a predetermined time

In some exemplary embodiments, the acceptable range may be set by the manager.

In some exemplary embodiments, the acceptable range may include an error of the amounts of electricity measured by the first and second watt-hour meters.

In some exemplary embodiments, the acceptable range may include an error generated due to the amount of electricity lost in electric equipment between the first and second watt-hour meters.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows an embodiment of a system for electric energy management according to the present invention;

FIG. 2 shows an example in which first and second watt-hour meters individually transmit information necessary for determining the presence of electricity theft to a remote server;

FIG. 3 shows an example in which the first watt-hour meter collects information necessary for determining the presence of electricity theft from the second watt-hour meters and transmits the collected information to the remote server;

FIGS. 4 and 5 show an example for illustrating a method in which the remote server determines the presence of electricity theft using admittance;

FIGS. 6 and 7 show an example for illustrating a method in which the remote server determines the presence of electricity theft using impedance;

FIG. 8 schematically shows an embodiment in which the remote server informs a manager of the presence of electricity theft;

FIG. 9 shows an example of a functional block diagram of a system for electric energy management;

FIGS. 10 and 11 shows an example of a process in which a system for electric energy management operates according to a first embodiment of the present invention;

FIGS. 12 and 13 shows an example of a process in which a system for electric energy management operates according to a second embodiment of the present invention;

FIGS. 14 and 15 shows an example of a process in which a system for electric energy management operates according to a third embodiment of the present invention; and

FIGS. 16 and 17 shows an example of a process in which a system for electric energy management operates according to a fourth embodiment of the present invention.

### DETAILED DESCRIPTION OF THE INVENTION

The present invention is described more fully hereinafter with reference to the accompanying drawings, in which embodiments of the present invention are shown. This present invention may, however, be embodied in many different forms and should not be construed as limited to the embodiments set forth herein. Rather, these embodiments are provided so that this disclosure is thorough, and will fully convey the scope of the present invention to those skilled in the art.

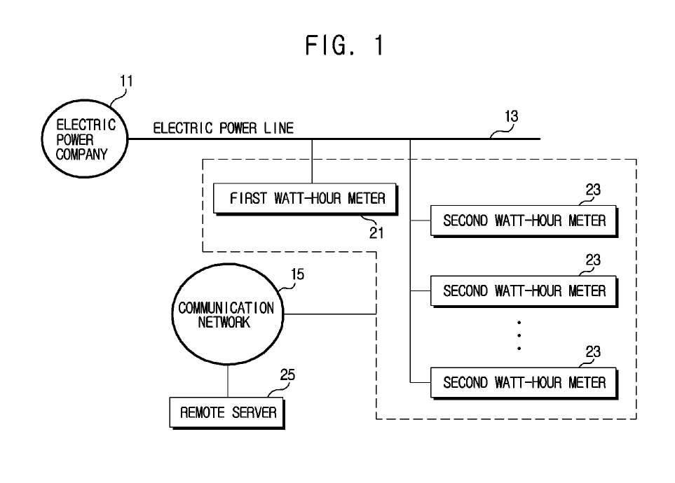

FIG. 1 shows an embodiment of a system for electric energy management according to the present invention. An electric power company 11 supplies electric energy through an electric power line 13, and a first watt-hour meter 21 and a plurality of second watt-hour meter 23 are installed in the electric power line 13.

The first and second watt-hour meters 21 and 23 are installed at places on the same electric power line 13, respectively. The first watt-hour meter 21 is installed at an upper place on the electric power line 13, and the second watt-hour meter 21 are installed at a lower position on the electric power line 13.

Here, it should be noted that the upper and lower places are relative concepts.

For example, when the amount of power measured by a watt-hour meter A is the total amount of power measured by a plurality of watt-hour meters B, the position of the watt-hour meter A becomes an upper place, and the position of each of the watt-hour meters B becomes a lower place.

That is, in the case of a shared accommodation, such as an apartment building, composed of a plurality of households, the first watt-hour meter 21 may be installed in a place at which the electric power line 13 enters into the corresponding shared accommodation, a watt-hour meter installed in each of the household may perform the function of the second watt-hour meter 23.

The first watt-hour meter 21 may be installed at a place, such as a telegraph post, branched into the plurality of the households, and the watt-hour meter of each of the households connected to an electric power line branched from the telegraph post may perform the function of the second watt-hour meter 23.

The system according to the present invention includes a first watt-hour meter 21, a plurality of second watt-hour meters and a remote server 25.

Each of the first and second watt-hour meters 21 and 23 basically measures the amount of electricity supplied to a load based on its own installation position.

The ‘amount of electricity’ in relation to the present invention refers to the whole information related to electric energy, which can be used in the calculation of admittance or impedance, in spite of its dictionary meaning.

As a specific example, the amount of electricity measured by the first and second watt-hour meters 21 and 23 may be a passive power amount (VA-hour), active power amount (Watt-hour), voltage integrated amount (V²-hour) or current integrated amount (I²-hour), which is an integrated value, an apparent power (VA), effective power (Watt), voltage effective power (Vᵣₘₛ) or current effective power (Iᵣₘₛ), which is an instantaneous value, or a mean value of these values.

The remote server 25 collects information necessary for determining the presence of electricity theft from the first and second watt-hour meters 21 and 23 through a communication network 15, and determines the presence of electricity theft using the collected information.

The communication network 15 may include various kinds of networks.

For example, the communication network 15 may include a power line communication (PLC) network, an Internet network, a code division multiple access (CDMA) network, a personal communication service (PCS) network, a personal handyphone system (PHS) network, a wireless broadband Internet (Wibro) network, and the like.

The first and second watt-hour meters 21 and 23 may transmit information necessary for determining the presence of electricity theft through several paths.

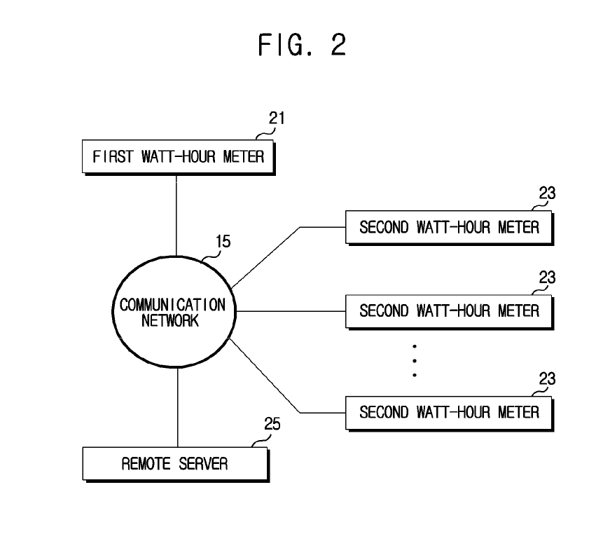

That is, as shown in the example of FIG. 2, the first and second watt-hour meters 21 and 23 may individually transmit the information necessary for determining the presence of electricity theft to the remote server 25.

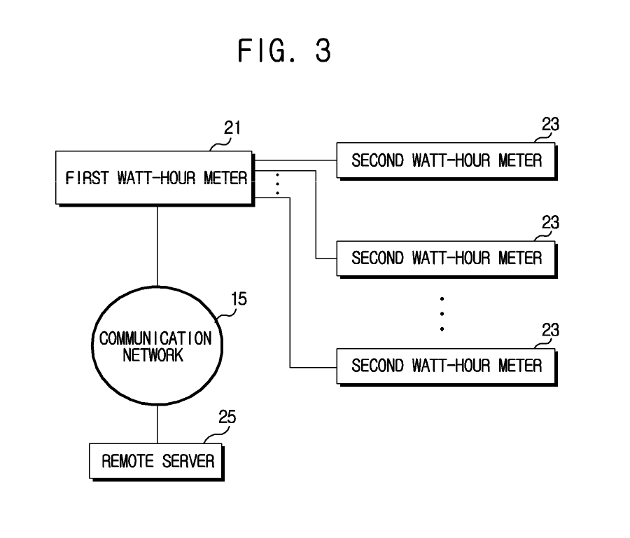

As shown in the example of FIG. 3, the second watt-hour meters 23 may transmit information necessary for determining the presence of electricity theft to the first watt-hour meter 21, and the first watt-hour meter 12 may collect the information necessary for determining the presence of electricity theft from the second watt-hour meters 23 and then transmit the collected information together with its own information to the remote server 25. In this instance, the first and second watt-hour meters 21 and 23 may communicated with each other using various wired/wireless communication schemes.

Meanwhile, the system according to the present invention may be variously configured according to the kind of information that the first and second watt-hour meters 21 and 23 transmit to the remote server 25, and whether the remote server 25 uses admittance or impedance so as to determine the presence of electricity theft.

The admittance or impedance is calculated based on the amount of electricity measured by the first and second watt-hour meters 21 and 23.

For convenience of illustration, the admittance and impedance calculated from the amount of electricity measured by the first watt-hour meter 21 are referred to as a first admittance and a first impedance, respectively. The admittance and impedance calculated from the amount of electricity measured by the second watt-hour meter 23 are referred to as a second admittance and a second impedance, respectively.

Since there exist a plurality of second watt-hour meters 23, there exist a plurality of second admittances or a plurality of second impedances.

Various embodiments of the system according to the present invention will now be described in detail.

### First Embodiment

The first embodiment of the system according to the present invention is configured so that each of the first and second watt-hour meters 21 and 23 calculates admittance by itself. The remote server 25 collects information on a first admittance and information on second admittances through the communication network 15, and determines the presence of electricity theft based on the information.

Each of the first and second watt-hour meters 21 and 23 measures an amount of electricity supplied to a load based on its own installation position, and calculates admittance based on the measured amount of electricity.

Each of the first and second watt-hour meters 21 and 23 may calculate admittance using the integrated, instantaneous or mean value of various amounts of electricity. Various examples for calculating admittance are represented by expressions 1 to 10.

$$\begin{matrix}Y = \frac{ \begin{matrix}integrated value of \\ apparent power [ VA - hour ]\end{matrix} }{\begin{matrix}integrated value of \\ square of voltage [ {V}^{2} - hour ]\end{matrix}} & [ Expression 1 ] \\ Y = \frac{ \begin{matrix}integrated value of \\ active power [ Watt - hour ]\end{matrix} }{\begin{matrix}integrated value of \\ square of voltage [ {V}^{2} - hour ]\end{matrix}} & [ Expression 2 ] \\ Y = \frac{ \begin{matrix}integrated value of \\ square of current [ {I}^{2} - hour ]\end{matrix} }{\begin{matrix}integrated value of \\ apparent power [ VA - hour ]\end{matrix}} & [ Expression 3 ] \\ Y = \frac{ \begin{matrix}integrated value of \\ square of current [ {I}^{2} - hour ]\end{matrix} }{\begin{matrix}integrated value of \\ active power [ Watt - hour ]\end{matrix}} & [ Expression 4 ] \\ Y = \sqrt{\frac{\begin{matrix}integrated value of \\ square of current [ {I}^{2} - hour ]\end{matrix}}{\begin{matrix}integrated value of \\ square of voltage [ {V}^{2} - hour ]\end{matrix}}} & [ Expression 5 ] \\ Y = \frac{apparent power [ VA ]}{square of effective value of voltage [ {V}_{rms}^{2} ]} & [ Expression 6 ] \\ Y = \frac{active power [ Watt ]}{square of effective value of voltage [ {V}_{rms}^{2} ]} & [ Expression 7 ] \\ Y = \frac{square of effective value of current [ {I}_{rms}^{2} ]}{apparent power [ VA ]} & [ Expression 8 ] \\ Y = \frac{square of effective value of current [ {I}_{rms}^{2} ]}{active power [ Watt ]} & [ Expression 9 ] \\ Y = \frac{effective value of current [ {I}_{rms} ]}{effective value of voltage [ {V}_{rms} ]} & [ Expression 10 ]\end{matrix}$$

In the expressions 1 to 10, ‘Y’ denotes admittance, the expressions 2, 4, 7 and 9 may be used only when the power factors of the first and second watt-hour meters 21 and 23 are identical to each other.

As shown in the example of FIG. 2, the first and second watt-hour meters 21 and 23 may individually transmit information on the calculated admittance to the remote server 25 through the communication network 15. Alternately, as shown in the example of FIG. 3, the first watt-hour meter 21 may collect information on the admittances respectively calculated by the second watt-hour meters 23 and transmit the information together with the information on its own calculated admittance to the remote server 25 through the communication network 15.

The remote server 25 receives information on a first admittance calculated by the first watt-hour meter 21 and information on second admittances respectively calculated by the second watt-hour meters 23, and compares the first admittance with the total sum of the second admittances. Then, the remote server 25 determines the presence of occurrence of electricity theft based on a degree to which the difference between the first admittance and the total sum of the second admittances is deviated from an acceptable range.

That is, theoretically, the total sum of the second admittances necessarily corresponds to the first admittance. Therefore, if the difference value between the first admittance and the total sum of the second admittances is deviated from the acceptable range, it may be determined that electricity theft is made at anywhere of lower place at which the first watt-hour meter 21 is installed.

Accordingly, the first and second admittances are necessarily calculated based on information on the amount of electricity at the same time.

For example, if admittance is calculated using the amount of instantaneous electricity, the first and second watt-hour meters 21 and 23 necessarily calculate the respective admittances based on information on amounts of electricity measured at the same time (e.g., just at 6 and 18 o'clock everyday).

If admittance is calculated using the amount of accumulated electricity, the first and second watt-hour meters 21 and 23 necessarily calculate the respective admittances based on information on amounts of electricity accumulated during the same period (e.g., from 12 o'clock, first January, 2010 to the present).

The acceptable range may be variously set as occasion demands. Particularly, the first and second watt-hour meters 21 and 23 measure the amount of electricity, the acceptable range is preferably set in consideration of a measurement error that may occur even in a normal situation. The acceptable range may include an error that occurs because of the amount of electricity lost in electric equipment between the first and second watt-hour meters 21 and 23.

The acceptable range may be previously set by the remote server, or may be configured to be set by a manager.

In the latter example, the remote sever 25 may provide a user interface (UI) that enables the manager to set the acceptable range, or may receive an acceptable range set by the manager from another device.

As described above, the first and second admittances may be changed due to an error of the amount of electricity measured by the first and second watt-hour meters 21 and 23 even in a normal situation.

Therefore, the remote server 25 may determine the presence of electricity theft using mean values of the first and second admittances received for a certain period of time.

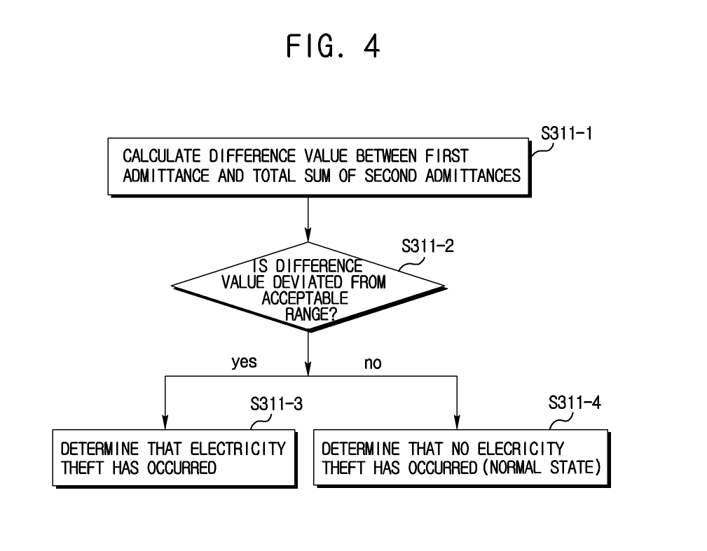

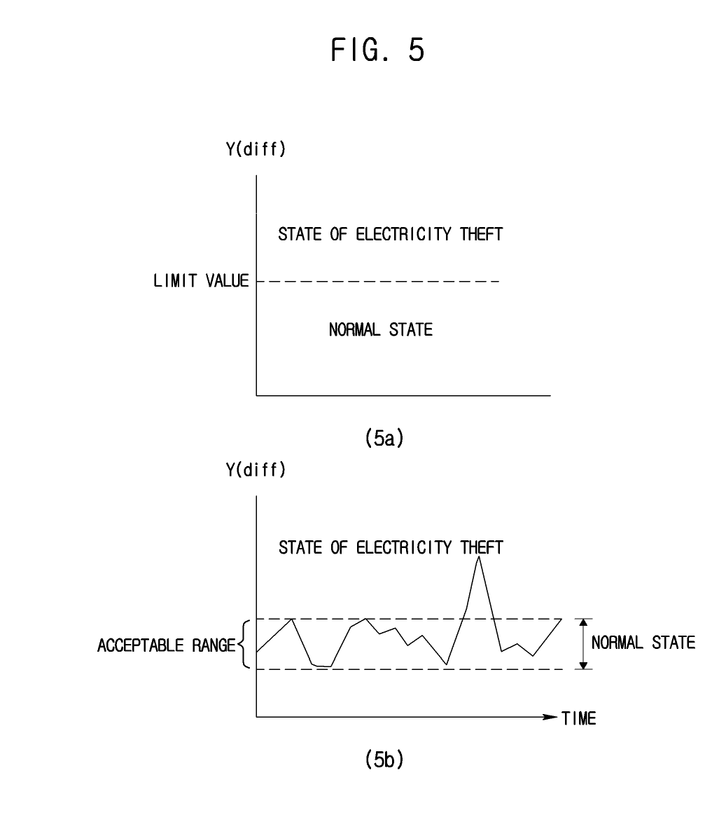

A method in which the remote server 25 determines the presence of occurrence of electricity theft will be described in detail with reference to FIGS. 4 and 5.

First, the remote server 25 calculates a difference value between a first admittance and the total sum of second admittances (S311-1). If it is assumed that the difference value is ‘Y(diff)’, the Y(diff) may be calculated using the following expression 11.

$$Y ( diff ) = \vert Y 1 - {\sum }_{i = 1}^{n} Y 2 ( i ) \vert \qquad [ Expression 11 ]$$

Here, Y1 denotes a first admittance, Y2(i) denotes a second admittance calculated by an i-th second watt-hour meter, and n denotes a number of second watt-hour meters.

If the Y(diff) is calculated as described above, the remote server 25 examines whether or not the Y(diff) is deviated from a previously set acceptable range (S311-2).

If it is examined that the Y(diff) is deviated from the acceptable range, the remote server 25 determines that electricity theft has occurred (S311-3). Otherwise, the remote server 25 determines that no electricity theft has occurred (normal state) (S311-4).

In this instance, the acceptable range may be set to a constant limit value as shown in the example of FIG. 5A. When the Y(diff) is the limit value or more, the remote server 25 determines that electricity theft has occurred. When the Y(diff) is less than the limit value, the remote server 25 determines that no electricity theft has occurred (normal state).

The remote server 25 may determine the presence of electricity theft according to the fluctuation in the Y(diff) as shown in the example of FIG. 5B.

That is, the Y(diff) may be fluctuated due to an error of the amount of electricity measured by the first and second watt-hour meters 21 and 23 even in a normal situation, but the variation width is maintained within a certain acceptable range. However, if electricity theft occurs, the Y(diff) will be deviated from the acceptable range and considerably fluctuated. Therefore, if the Y(diff) is deviated from the acceptable range according to the fluctuation in the Y(diff), the remote server 25 can determine that the electricity theft has occurred.

### Second Embodiment

The second embodiment of the system according to the present invention is configured so that the remote server 25 calculates first and second admittances by itself using information on amounts of electricity measured by the first and second watt-hour meters 21 and 23 and then determines the presence of electricity theft.

Each of the first and second watt-hour meters 21 and 23 measures an amount of electricity supplied to a load based on its own installation position.

As shown in the example of FIG. 2, the first and second watt-hour meters 21 and 23 may individually transmit the information on the measured amount of electricity to the remote server 25 through the communication network 15. Alternately, as shown in the example of FIG. 3, the first watt-hour meter 21 may collect the information on amounts of electricity, respectively measured by the second watt-hour meters 23 and transmit the information together with the information on its own measured amount of electricity to the remote server 25 through the communication network 15.

The remote server 25 calculates first and second admittances by various methods as shown in examples of the expressions 1 to 10, using information on the amount of electricity measured by the first and second watt-hour meters 21 and 23.

The remote server 25 compares the calculated first admittance with the total sum of the calculated second admittances, and determines the presence of occurrence of electricity theft based on a degree to which the difference between the first admittance and the total sum of the second admittances is deviated from an acceptable range.

That is, theoretically, the total sum of the second admittances necessarily corresponds to the first admittance. Therefore, if the difference value between the first admittance and the total sum of the second admittances is deviated from the acceptable range, it may be determined that electricity theft is made at anywhere of lower place at which the first watt-hour meter 21 is installed.

Accordingly, the first and second watt-hour meters 21 and 23 necessarily transmit the respective amounts of electricity measured based on information on the amount of electricity at the same time.

For example, if the amount of instantaneous electricity is measured, the first and second watt-hour meters 21 and 23 necessarily measure the respective amount of electricity at the same time (e.g., just at 6 and 18 o'clock everyday). If the amount of electricity accumulated for a certain period of time is measured, the first and second watt-hour meters 21 and 23 necessarily measure the respective amounts of electricity accumulated during the same period (e.g., from 12 o'clock, first January, 2010 to the present).

The acceptable range may be variously set as occasion demands. Particularly, the first and second watt-hour meters 21 and 23 measure the amount of electricity, the acceptable range is preferably set in consideration of a measurement error that may occur even in a normal situation. The acceptable range may include an error that occurs because of the amount of electricity lost in electric equipment between the first and second watt-hour meters 21 and 23.

The acceptable range may be previously set by the remote server, or may be configured to be set by a manager.

In the latter example, the remote sever 25 may provide a UI that enables the manager to set the acceptable range, or may receive an acceptable range set by the manager from another device.

Since the first and second admittances may be changed due to an error of the amount of electricity measured by the first and second watt-hour meters 21 and 23 even in a normal situation, the remote server 25 may determine the presence of electricity theft using mean values of the first and second admittances received for a certain period of time.

After calculating the first and second admittances, the remote server 25 may determine the presence of electricity theft as described with reference to FIGS. 4 and 5.

That is, as shown in the example of FIG. 5A, the remote server 25 may determine the presence of theft according to whether or not the difference value Y(diff) between the first admittance and the total sum of the second admittances is a previously set limit value or more.

As shown in the example of FIG. 5B, the remote server 25 may determine the presence of electricity theft according to the fluctuation in the difference value Y(diff) between the first admittance and the total sum of the second admittances.

### Third Embodiment

The third embodiment of the system according to the present invention is configured so that each of the first and second watt-hour meters 21 and 23 calculates impedance by itself. The remote server 25 collects information on a first impedance and information on second impedances through the communication network 15 and then determines the presence of electricity theft based on the collected information.

Each of the first and second watt-hour meters 21 and 23 measures an amount of electricity supplied to a load based on its own installation position, and calculates impedance based on the measured amount of electricity.

Each of the first and second watt-hour meters 21 and 23 may calculate impedance using the integrated, instantaneous or mean value of various amounts of electricity. The impedance Z may be calculated as a reciprocal number of each of the expressions 1 to 10 as shown in the following expression 12.

$$Z = \frac{1}{Y} \qquad [ Expression 12 ]$$

As shown in the example of FIG. 2, the first and second watt-hour meters 21 and 23 may individually transmit information on the calculated impedance to the remote server 25 through the communication network 15. Alternately, as shown in the example of FIG. 3, the first watt-hour meter 21 may collect information on the impedances respectively calculated by the second watt-hour meters 23 and transmit the information together with the information on its own calculated impedance to the remote server 25 through the communication network 15.

The remote server 25 receives information on a first impedance calculated by the first watt-hour meter 21 and information on second impedances respectively calculated by the second watt-hour meters 23, and compares the first impedance with the equivalent value of the second impedances. Then, the remote server 25 determines the presence of occurrence of electricity theft based on a degree to which the difference between the first admittance and the equivalent value of the second admittances is deviated from an acceptable range.

That is, theoretically, the equivalent value of the second impedances necessarily corresponds to the first impedance. Therefore, if the difference value between the first impedance and the equivalent value of the second impedances is deviated from the acceptable range, it may be determined that electricity theft is made at anywhere of lower place at which the first watt-hour meter 21 is installed.

Accordingly, the first and second impedances are necessarily calculated based on based on information on the respective amounts of electricity measured at the same time.

For example, if impedance is calculated using the amount of instantaneous electricity, the first and second watt-hour meters 21 and 23 necessarily calculate the respective impedances based on information on amounts of electricity measured at the same time (e.g., just at 6 and 18 o'clock everyday).

If impedance is calculated using the amount of accumulated electricity, the first and second watt-hour meters 21 and 23 necessarily calculate the respective impedances based on information on amounts of electricity accumulated during the same period (e.g., from 12 o'clock, first January, 2010 to the present).

The acceptable range may be variously set as occasion demands. Particularly, the first and second watt-hour meters 21 and 23 measure the amount of electricity, the acceptable range is preferably set in consideration of a measurement error that may occur even in a normal situation.

The acceptable range may include an error that occurs because of the amount of electricity lost in electric equipment between the first and second watt-hour meters 21 and 23.

The acceptable range may be previously set by the remote server, or may be configured to be set by a manager.

In the latter example, the remote sever 25 may provide a UI that enables the manager to set the acceptable range, or may receive an acceptable range set by the manager from another device.

The first and second impedances may be changed due to an error of the amount of electricity measured by the first and second watt-hour meters 21 and 23 even in a normal situation.

Therefore, the remote server 25 may determine the presence of electricity theft using mean values of the first and second impedances received for a certain period of time.

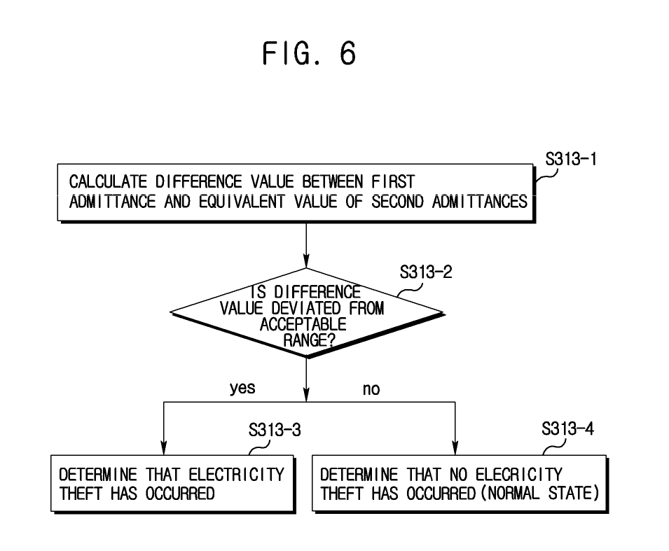

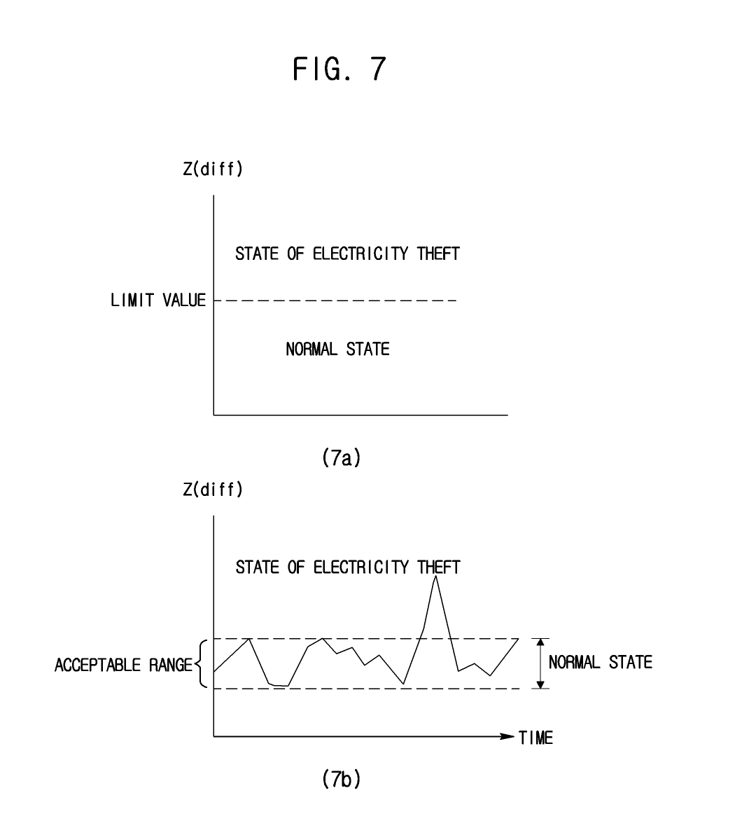

A method in which the remote server 25 determines the presence of the occurrence of electricity theft will be described in detail with reference to FIGS. 6 and 7.

First, the remote server 25 calculates a difference value between a first impedance and the equivalent value of second admittances (S313-1). If it is assumed that the difference value is ‘Z(diff)’, the Z(diff) may be calculated using the following expression 11.

$$Z ( diff ) = \vert Z 1 - \frac{1}{{\sum }_{i = 1}^{n} \frac{1}{Z 2 ( i )}} \vert \qquad [ Expression 13 ]$$

Here, Z1 denotes a first impedance, Z2(i) denotes a second impedance calculated by an i-th second watt-hour meter, and n denotes a number of second watt-hour meters.

If the Z(diff) is calculated as described above, the remote server 25 examines whether or not the Z(diff) is deviated from a previously set acceptable range (S313-2).

If it is examined that the Z(diff) is deviated from the acceptable range, the remote server 25 determines that electricity theft has occurred (S313-3). Otherwise, the remote server 25 determines that no electricity theft has occurred (normal state) (S313-4).

In this instance, the acceptable range may be set to a constant limit value as shown in the example of FIG. 7A. When the Z(diff) is the limit value or more, the remote server 25 determines that electricity theft has occurred. When the Z(diff) is less than the limit value, the remote server 25 determines that no electricity theft has occurred (normal state).

The remote server 25 may determine the presence of electricity theft according to the fluctuation in the Z(diff).

That is, the Z(diff) may be fluctuated due to an error of the amount of electricity measured by the first and second watt-hour meters 21 and 23 even in a normal situation, but the variation width is maintained within a certain acceptable range. However, if electricity theft occurs, the Z(diff) will be deviated from the acceptable range and considerably fluctuated. Therefore, if the Z(diff) is deviated from the acceptable range according to the fluctuation in the Z(diff), the remote server 25 can determine that the electricity theft has occurred.

### Fourth Embodiment

The fourth embodiment of the system according to the present invention is configured so that the remote server 25 calculates first and second impedances by itself using information on amounts of electricity measured by the respective first and second watt-hour meters 21 and 23 and then determines the presence of electricity theft.

Each of the first and second watt-hour meters 21 and 23 measures an amount of electricity supplied to a load based on its own installation position.

As shown in the example of FIG. 2, the first and second watt-hour meters 21 and 23 may individually transmit the information on the measured amount of electricity to the remote server 25 through the communication network 15. Alternately, as shown in the example of FIG. 3, the first watt-hour meter 21 may collect the information on amounts of electricity, respectively measured by the second watt-hour meters 23 and transmit the information together with the information on its own measured amount of electricity to the remote server 25 through the communication network 15.

The remote server 25 calculates first and second admittances using information on the amount of electricity measured by the first and second watt-hour meters 21 and 23.

The remote server 25 compares the calculated first impedance with the equivalent value of the calculated second impedances, and determines the presence of occurrence of electricity theft based on a degree to which the difference between the first impedance and the equivalent value of the second impedances is deviated from an acceptable range.

That is, theoretically, the equivalent value of the second impedances necessarily corresponds to the first impedance. Therefore, if the difference value between the first impedance and the equivalent value of the second impedances is deviated from the acceptable range, it may be determined that electricity theft is made at anywhere of lower place at which the first watt-hour meter 21 is installed.

Accordingly, the first and second watt-hour meters 21 and 23 necessarily transmit the respective amounts of electricity measured based on information on the amount of electricity at the same time.

For example, if the amount of instantaneous electricity is measured, the first and second watt-hour meters 21 and 23 necessarily measure the respective amount of electricity at the same time (e.g., just at 6 and 18 o'clock everyday). If the amount of electricity accumulated for a certain period of time is measured, the first and second watt-hour meters 21 and 23 necessarily measure the respective amounts of electricity accumulated during the same period (e.g., from 12 o'clock, first January, 2010 to the present).

The acceptable range may be variously set as occasion demands. Particularly, the first and second watt-hour meters 21 and 23 measure the amount of electricity, the acceptable range is preferably set in consideration of a measurement error that may occur even in a normal situation. The acceptable range may include an error that occurs because of the amount of electricity lost in electric equipment between the first and second watt-hour meters 21 and 23.

The acceptable range may be previously set by the remote server, or may be configured to be set by a manager.

In the latter example, the remote sever 25 may provide a UI that enables the manager to set the acceptable range, or may receive an acceptable range set by the manager from another device.

The first and second impedances may be changed due to an error of the amount of electricity measured by the first and second watt-hour meters 21 and 23 even in a normal situation.

Therefore, the remote server 25 may determine the presence of electricity theft using mean values of the first and second impedances received for a certain period of time.

After calculating the first and second impedances, the remote server 25 may determine the presence of electricity theft as described with reference to FIGS. 6 and 7.

That is, as shown in the example of FIG. 7A, the remote server 25 may determine the presence of theft according to whether or not the difference value Z(diff) between the first impedance and the equivalent of the second impedance is a previously set limit value or more.

As shown in the example of FIG. 7B, the remote server 25 may determine the presence of electricity theft according to the fluctuation in the difference value Z(diff) between the first impedance and the equivalent value of the second impedances.

In the system according to the first to fourth embodiments, the remote server 25 may periodically determine the presence of electricity theft at a predetermined time.

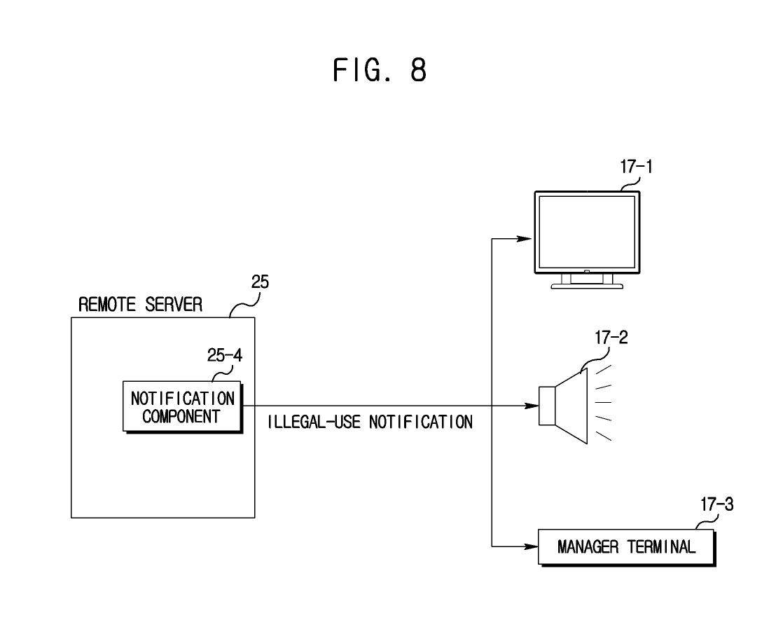

In the system according to the first to fourth embodiments, when it is determined that electricity theft has occurred as shown in the example of FIG. 8, the remote server 25 may further include a notification component 25-4 for notifying and warning the manager of the electricity theft.

The notification component 25-4 may be configured to notify the manager of the electricity theft using various methods.

For example, the notification component 25-4 may display a warning message on a display device such as a monitor screen 17-1, or may generate an alarm sound through an alarm device 17-2.

The notification component 25-4 may transmit a warning message to a manager terminal 17-3 through various wired/wireless communication networks. For example, the notification component 25-4 may transmit a warning mail to the manager through an Internet network, or may transmit a warning message to a cellular phone of the manager through a mobile communication network.

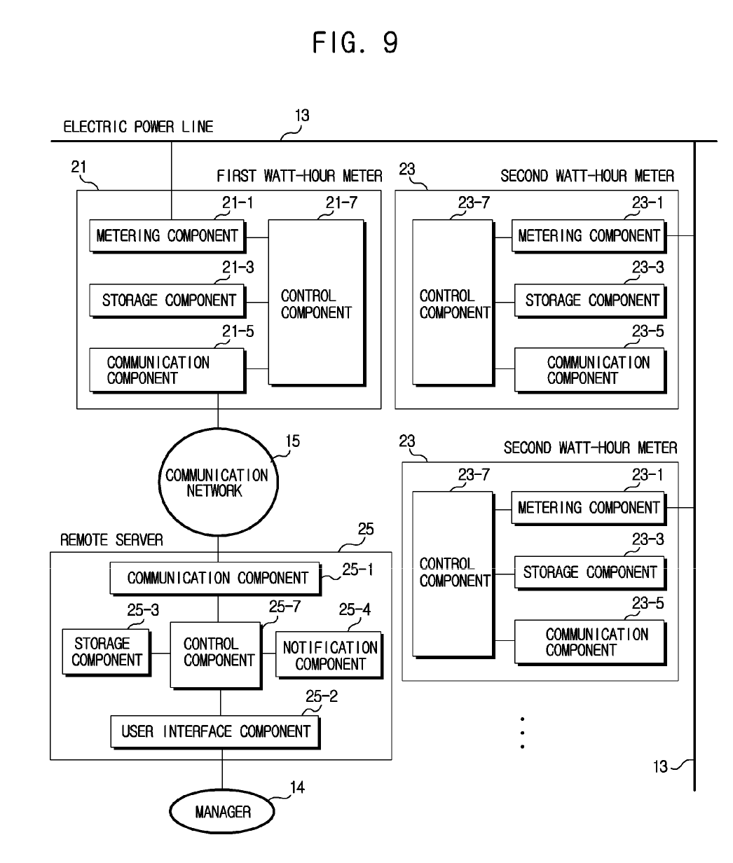

FIG. 9 shows an example of a functional block diagram of the first watt-hour meter 21, the second watt-hour meters and the remote server 25.

The first and second watt-hour meters 21 and 23 may include metering components 21-1 and 23-1, storage components 21-3 and 23-3, communication components 21-5 and 23-5, and control components 21-7 and 23-7, respectively.

Each of the metering components 21-1 and 23-1 of the first and second watt-hour meters 21 and 23 measures various kinds of information on the amount of electricity at a corresponding place on the electric power line 13.

Each of the storage components 21-3 and 23-3 of the first and second watt-hour meters 21 and 23 is a nonvolatile storage medium for storing digital data.

Each of the control components 21-7 and 23-7 of the first and second watt-hour meters 21 and 23 is configured as a microprocessor, central processing unit (CPU) or the like so as to generally control the watt-hour meter. The control components 21-7 and 23-7 of the first and second watt-hour meters 21 and 23 store and manage the amounts of electricity measured the metering components 21-1 and 21-3 in the storage components 21-3 and 23-3, respectively.

Each of the control components 21-7 and 23-7 of the first and second watt-hour meters 21 and 23 communicates with another watt-hour meter or the remote server 25 through each of the communication components 21-5 and 23-5 and transmits information necessary for determining the presence of electricity theft to the watt-hour meter or the remote server 25.

The information necessary for determining the presence of electricity theft may be information on admittance, impedance or the amount of electricity, which is required to calculate the admittance or impedance.

A communication component 25-1 of the remote sever 25 receives information necessary for determining the presence of electricity theft through the communication network 15. A storage component 25-3 of the remote server 25 is a nonvolatile storage medium, and stores various kinds of information related to the operation of the remote server 25.

A control component 25-7 of the remote server 25 may be configured using a CPU, and generally controls the remote server 25. Particularly, the control component 25-7 determines whether or not electricity theft occurs using the information necessary for determining the presence of the electricity theft, received by the communication component 25-1.

A user interface component 25-2 of the remote server 25 enables a manager 14 to input information or command necessary for the operation of the remote server 25.

For example, the manager 14 may set an acceptable range that becomes a reference for determining the presence of electricity theft through the user interface component 25-2, or may set information on a period in which to determine the presence of electricity theft, a cellular phone number of the manager 14, to which a warning message is to be transmitted, and the like.

In a case where it is determined that electricity theft has occurs, the notification component 25-4 function to inform the manager 14 of the occurrence of the electricity theft as described with reference to FIG. 8.

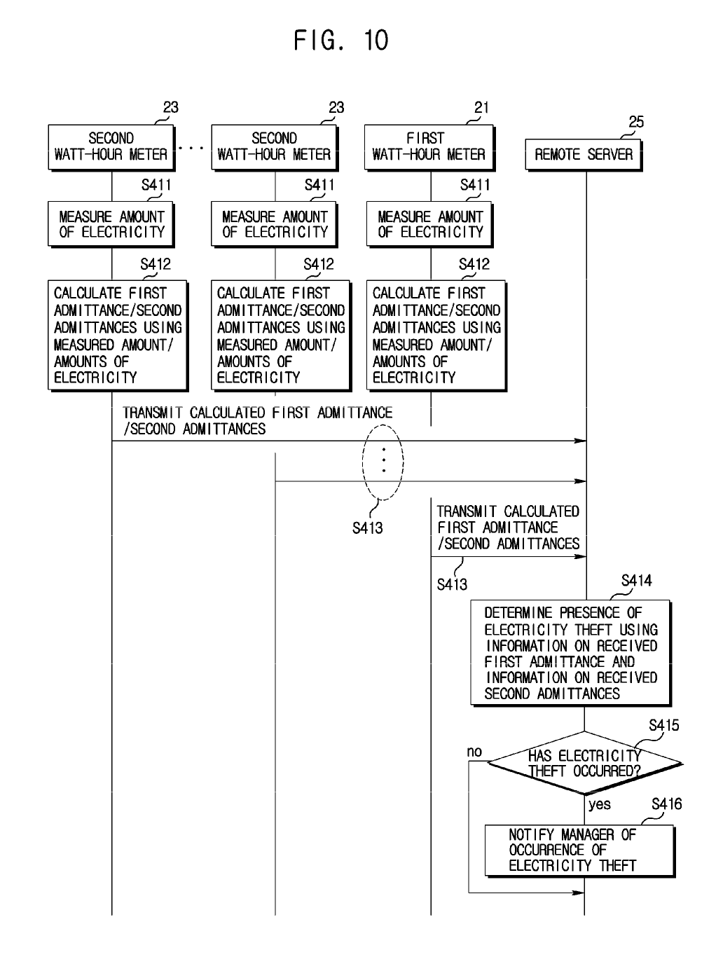

The entire process in which the system of each of the embodiments according to the present invention operates will be described with reference to FIGS. 10 to 17. For convenience for illustration, this will be described using the example of the functional block diagram shown in FIG. 9.

FIG. 10 shows an embodiment in which each of the first and second watt-hour meters 21 and 23 individually transmits information on admittance to the remote server 25 in the system of the first embodiment.

Each of the metering components 21-1 and 23-1 of the first and second watt-hour meters 21 and 23 measures an amount of electricity at its own installation position (S411).

The control component 21-7 of the first watt-hour meter 21 calculates a first admittance using information on the amount of electricity measured by the metering component 21-1, and each of the control components 23-7 of the second watt-hour meters 23 calculates a second admittance using information on the amount of electricity measured by the metering component 23-1 (S412).

The control component 21-7 of the first watt-hour meter 21 transmits information on the calculated first admittance to the remote server 25 through the communication component 21-5, and each of the control components 23-7 of the second watt-hour meters 23 transmits information on the calculated second admittance to the remote server 25 through the communication component 23-5 (S413).

The control component 25-7 of the remote server 25 receives the information on the first admittance and the information on the second admittances through the communication component 25-1, and determines the presence of occurrence of electricity theft based on the received information (S414).

In a case where it is determined that electricity theft has occurred, the remote server 25 notifies the manager 14 of the occurrence of the electricity theft through the notification component 25-4 (S415 and S416).

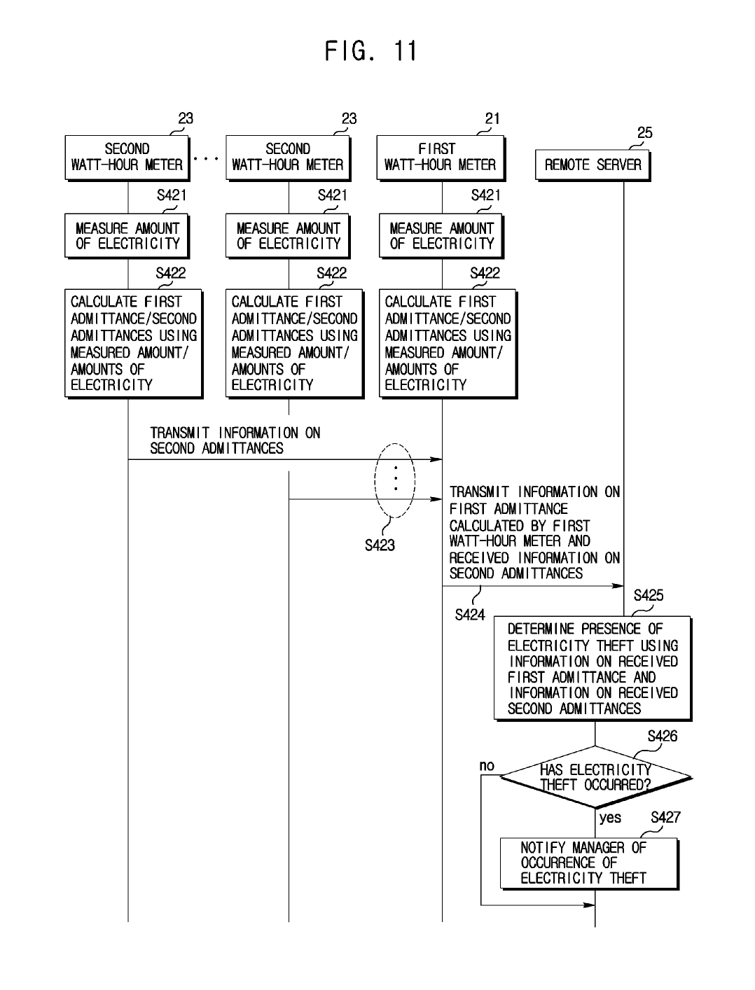

FIG. 11 shows an embodiment in which the first watt-hour meter 21 collects information on second admittances respectively calculated by the second watt-hour meters 23 and transmits the collected information together with information on a first admittance calculated by the first watt-hour meter 21 to the remote server 25 in the system of the first embodiment.

Each of the metering components 21-1 and 23-1 of the first and second watt-hour meters 21 and 23 measures an amount of electricity at its own installation position (S421).

The control component 21-7 of the first watt-hour meter 21 calculates a first admittance using information on the amount of electricity measured by the metering component 21-1, and each of the control components 23-7 of the second watt-hour meters 23 calculates a second admittance using information on the amount of electricity measured by the metering component 23-1 (S422).

Each of the control components 23-7 of the second watt-hour meters 23 transmits information on the calculated second admittance to the first watt-hour meter 21 through the communication component 23-5 (S423).

The control component 21-7 of the first watt-hour meter 21 collects the information the second admittances respectively received through the communication components 23-5 and transmits the collected information together with information on the first admittance calculated by the first watt-hour meter 21 to the remote server 25 through the communication component 21-5 (S424).

The control component 25-7 of the remote server 25 receives the information on the first admittance and the information on the second admittances through the communication component 25-1, and determines the presence of occurrence of electricity theft based on the received information (S425).

In a case where it is determined that electricity theft has occurred, the remote server 25 notifies the manager 14 of the occurrence of the electricity theft through the notification component 25-4 (S426 and S427).

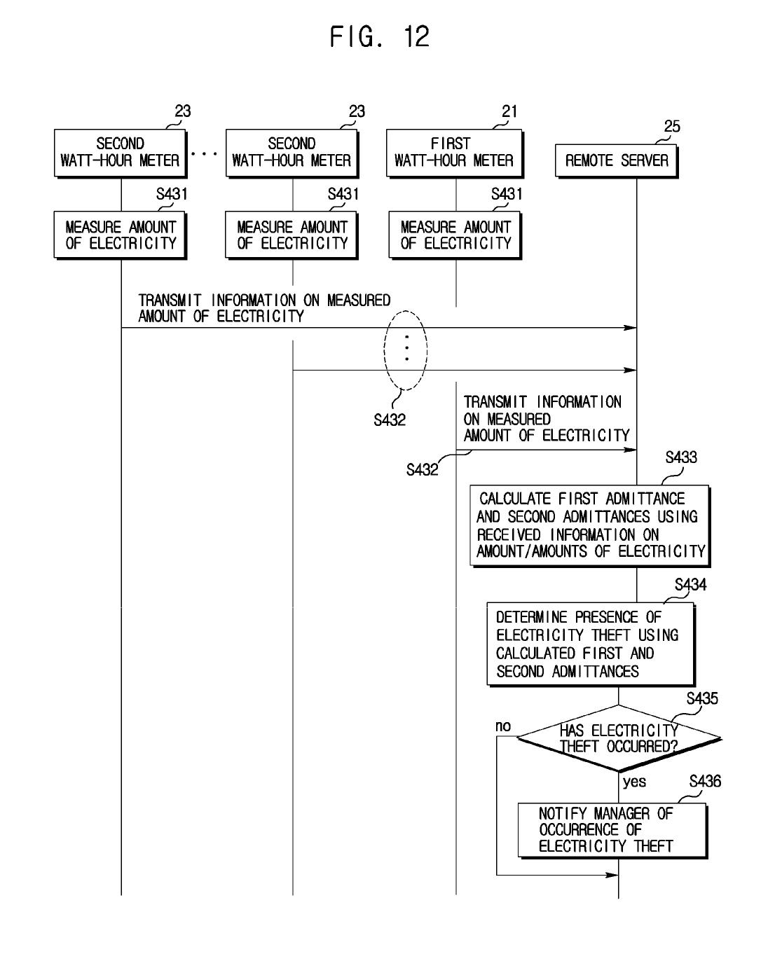

FIG. 12 shows an embodiment in which each of the first and second watt-hour meters 21 and 23 individually transmits information on an amount of electricity to the remote server 25 in the system of the second embodiment.

Each of the metering components 21-1 and 23-1 of the first and second watt-hour meters 21 and 23 measures an amount of electricity at its own installation position (S431).

The control component 21-7 of the first watt-hour meter 21 transmits information on the amount of electricity measured by the metering component 21-1 to the remote server 25 through the communication component 21-5, and each of the control components 23-7 of the second watt-hour meters 23 transmits information on the amount of electricity measured by the metering component 23-1 to the remote server 25 through the communication component 23-5 (S432).

The control component 25-7 of the remote server 25 receives the information on the amounts of electricity respectively measured by the first and second watt-hour meters 21 and 23 through the communication component 25-1, and calculates first and second admittances using the received information on the amounts of electricity (S433).

The control component 25-7 of the remote server 25 determines the presence of occurrence of electricity theft based on information on the calculated first and second admittances (S434). In a case where it is determined that the electricity theft has occurred, the remote server 25 notifies the manager 14 of the occurrence of the electricity theft through the notification component 25-4 (S435 and S436).

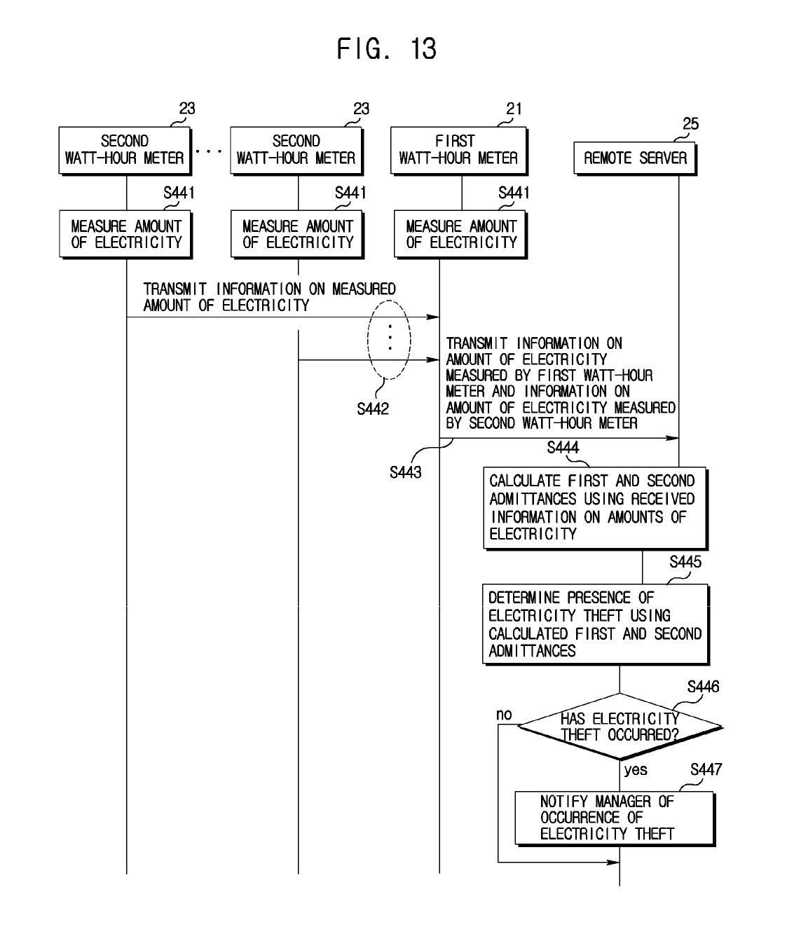

FIG. 13 shows an embodiment in which the first watt-hour meter 21 collects information on amounts of electricity respectively measured by the second watt-hour meters 23 and transmits the collected information together with information on an amount of electricity measured by the first watt-hour meter 21 to the remote server 25 in the system of the second embodiment.

Each of the metering components 21-1 and 23-1 of the first and second watt-hour meters 21 and 23 measures an amount of electricity at its own installation position (S441).

Each of the control components 23-7 of the second watt-hour meters 23 transmits information on the measured amount of electricity to the first watt-hour meter 21 through the communication component 23-5 (S442).

The control component 21-7 of the first watt-hour meter 21 collects the information on the amounts of electricity, respectively received by the second watt-hour meters 23 through the communication components 23-5, and transmits the collected information together with information on the amount of electricity measured by the first watt-hour meter 21 to the remote server 25 (S443).

The control component 25-7 of the remote meter 25 receives the information on the amounts of electricity respectively measured by the first and second watt-hour meters 21 and 23, and calculates first and second admittances using the received information on the amounts of electricity (S444).

The control component 25-7 of the remote meter 25 determines the presence of occurrence of electricity theft based on the information on the calculated first and second admittances (S445). In a case where it is determined that the electricity theft has occurred, the remote server 25 notifies the manager 14 of the occurrence of the electricity theft through the notification component 25-4 (S446 and S447).

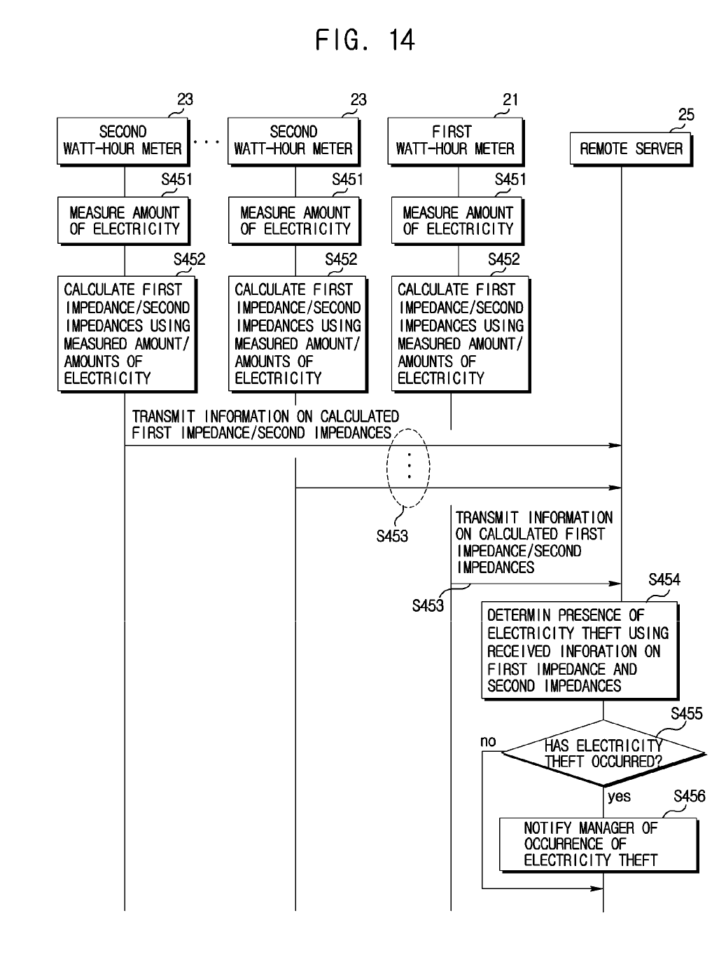

FIG. 14 shows an embodiment in which each of the first and second watt-hour meters 21 and 23 individually transmits information on impedance to the remote server 25 in the system of the third embodiment.

Each of the metering components 21-1 and 23-1 of the first and second watt-hour meters 21 and 23 measures an amount of electricity at its own installation position (S451).

The control component 21-7 of the first watt-hour meter 21 calculates a first impedance using information on the amount of electricity measured by the metering component 21-1, and each of the control components 23-7 of the second watt-hour meters 23 calculates a second impedance using information on the amount of electricity measured by the metering component 23-1 (S452).

The control component 21-7 of the first watt-hour meter 21 transmits information on the calculated first impedance to the remote server 25 through the communication component 21-5, and each of the control components 23-7 of the second watt-hour meters 23 transmits information on the calculated second impedance to the remote server 25 through the communication component 23-5 (S453).

The control component 25-7 of the remote server 25 receives the information on the first impedance and the information on the second impedances through the communication component 25-1, and determines the presence of occurrence of electricity theft based on the received information (S454). In a case where it is determined that electricity theft has occurred, the remote server 25 notifies the manager 14 of the occurrence of the electricity theft through the notification component 25-4 (S455 and S456).

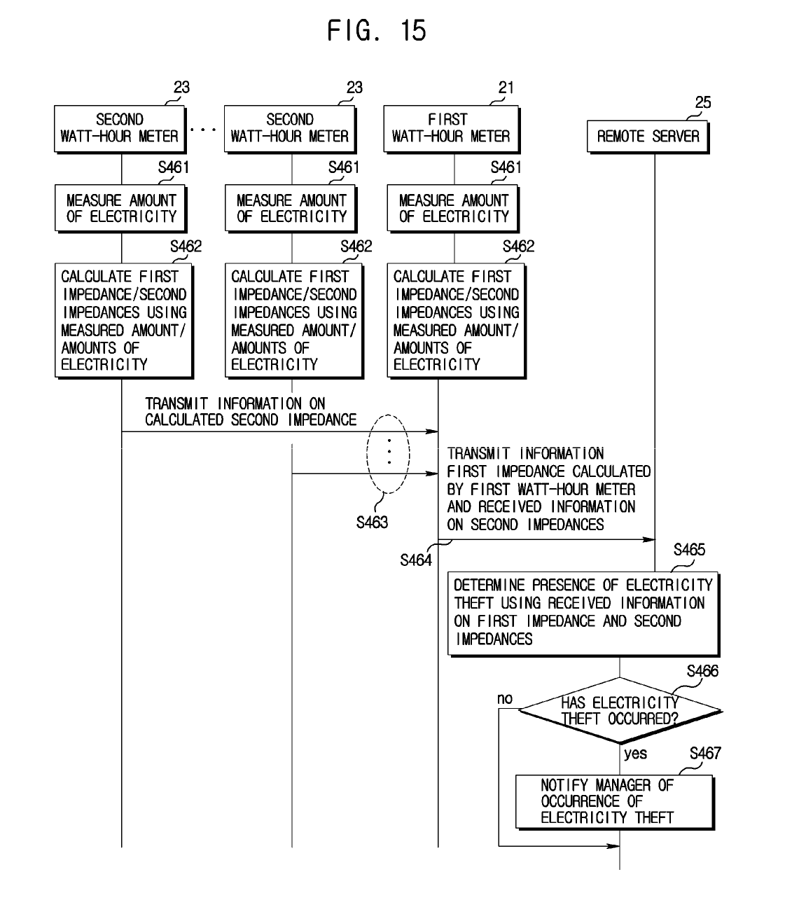

FIG. 15 shows an embodiment in which the first watt-hour meter 21 collects information on second impedances respectively calculated by the second watt-hour meters 23 and transmits the collected information together with information on a first impedance calculated by the first watt-hour meter 21 to the remote server 25 in the system of the third embodiment.

Each of the metering components 21-1 and 23-1 of the first and second watt-hour meters 21 and 23 measures an amount of electricity at its own installation position (S461).

The control component 21-7 of the first watt-hour meter 21 calculates a first impedance using information on the amount of electricity measured by the metering component 21-1, and each of the control components 23-7 of the second watt-hour meters 23 calculates a second impedance using information on the amount of electricity measured by the metering component 23-1 (S462).

Each of the control components 23-7 of the second watt-hour meters 23 transmits information on the calculated second impedance to the first watt-hour meter 21 through the communication component 23-5 (S463).

The control component 21-7 of the first watt-hour meter 21 collects the information the second impedances respectively received through the communication components 23-5 and transmits the collected information together with information on the first impedance calculated by the first watt-hour meter 21 to the remote server 25 through the communication component 21-5 (S464).

The control component 25-7 of the remote server 25 receives the information on the first impedance and the information on the second impedances through the communication component 25-1, and determines the presence of occurrence of electricity theft based on the received information (S465). In a case where it is determined that electricity theft has occurred, the remote server 25 notifies the manager 14 of the occurrence of the electricity theft through the notification component 25-4 (S466 and S467).

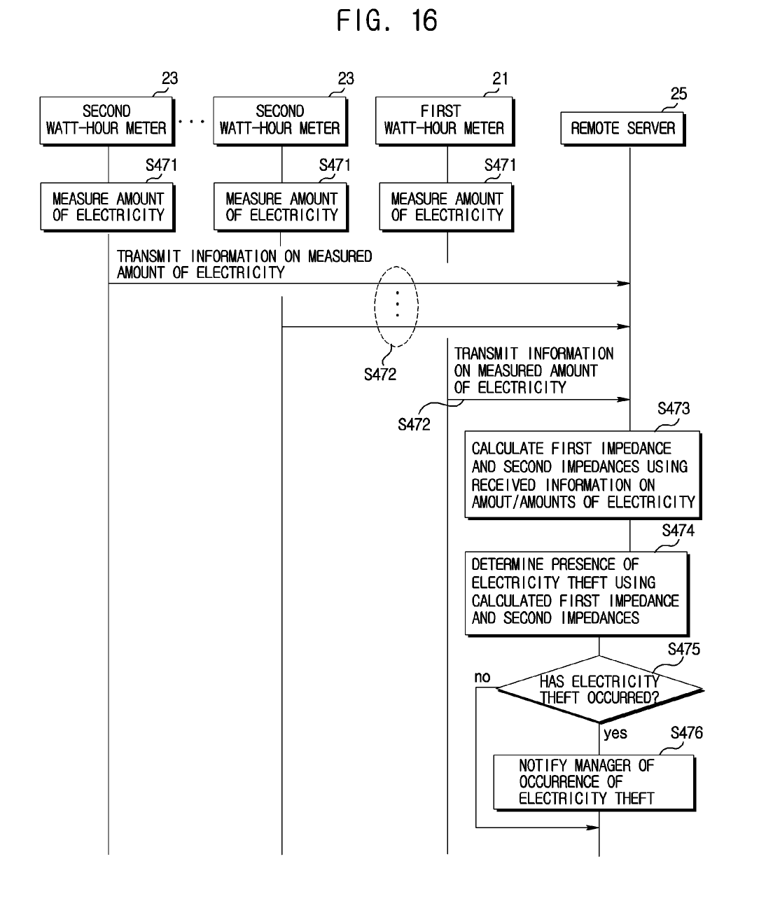

FIG. 16 shows an embodiment in which each of the first and second watt-hour meters 21 and 23 individually transmits information on an amount of electricity to the remote server 25 in the system of the fourth embodiment.

Each of the metering components 21-1 and 23-1 of the first and second watt-hour meters 21 and 23 measures an amount of electricity at its own installation position (S471).

The control component 21-7 of the first watt-hour meter 21 transmits information on the amount of electricity measured by the metering component 21-1 to the remote server 25 through the communication component 21-5, and each of the control components 23-7 of the second watt-hour meters 23 transmits information on the amount of electricity measured by the metering component 23-1 to the remote server 25 through the communication component 23-5 (S472).

The control component 25-7 of the remote server 25 receives the information on the amounts of electricity respectively measured by the first and second watt-hour meters 21 and 23 through the communication component 25-1, and calculates first and second impedances using the received information on the amounts of electricity (S473).

The control component 25-7 of the remote server 25 determines the presence of occurrence of electricity theft based on information on the calculated first and second impedances (S474). In a case where it is determined that the electricity theft has occurred, the remote server 25 notifies the manager 14 of the occurrence of the electricity theft through the notification component 25-4 (S475 and S476).

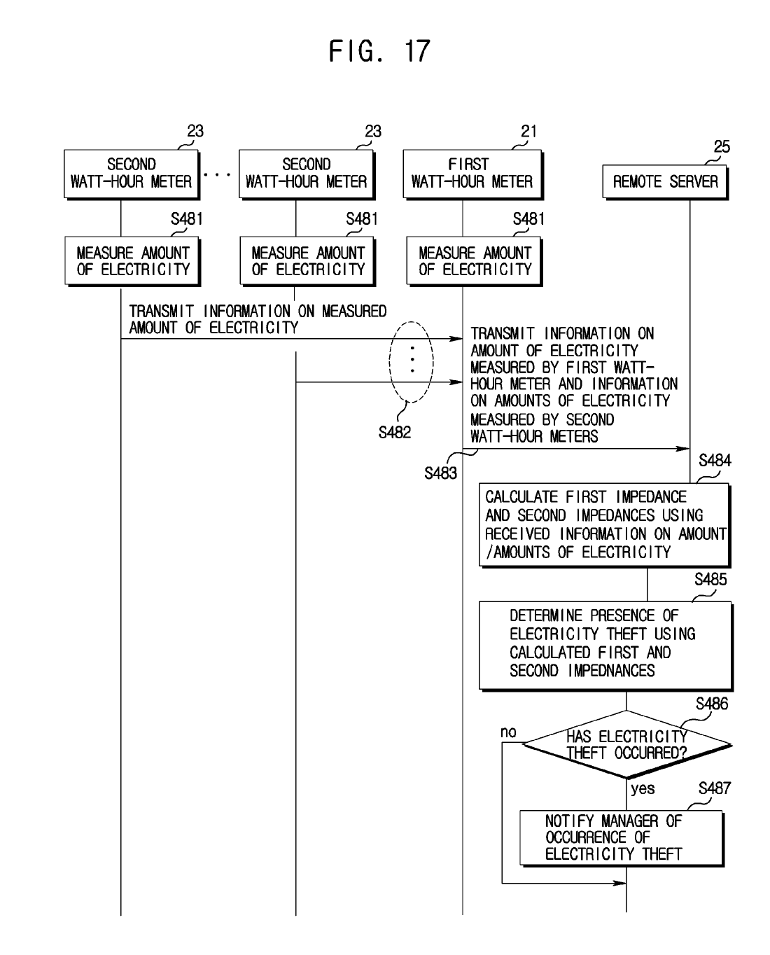

FIG. 17 shows an embodiment in which the first watt-hour meter 21 collects information on amounts of electricity respectively measured by the second watt-hour meters 23 and transmits the collected information together with information on an amount of electricity measured by the first watt-hour meter 21 to the remote server 25 in the system of the fourth embodiment.

Each of the metering components 21-1 and 23-1 of the first and second watt-hour meters 21 and 23 measures an amount of electricity at its own installation position (S481).

Each of the control components 23-7 of the second watt-hour meters 23 transmits information on the measured amount of electricity to the first watt-hour meter 21 through the communication component 23-5 (S482).

The control component 21-7 of the first watt-hour meter 21 collects the information on the amounts of electricity, respectively received by the second watt-hour meters 23 through the communication components 23-5, and transmits the collected information together with information on the amount of electricity measured by the first watt-hour meter 21 to the remote server 25 (S483).

The control component 25-7 of the remote server 25 receives the information on the amounts of electricity respectively measured by the first and second watt-hour meters 21 and 23, and calculates first and second impedances using the received information on the amounts of electricity (S484).

The control component 25-7 of the remote server 25 determines the presence of occurrence of electricity theft based on the information on the calculated first and second impedances (S485). In a case where it is determined that the electricity theft has occurred, the remote server 25 notifies the manager 14 of the occurrence of the electricity theft through the notification component 25-4 (S486 and S487).

According to the present invention, it is possible to monitor the presence of electricity theft using admittance or impedance corresponding to each place on an electric power line.

Particularly, the admittance or impedance is calculated using information on an amount of electricity measured at each place on the same electric power line.

Since information on amounts of electricity respectively measured at an upper place and several lower places on the same electric power line have a certain correspondence relation, a first admittance (or first impedance) calculated based on the information on the amount of electricity measured at the upper place and second admittances (or second impedances) respectively calculated based on information on the amounts of electricity measured at the lower places also have a certain relation.

For example, theoretically, the equivalent value of the second admittances (or second impedances) necessarily corresponds to the first admittance (or first impedance).

Thus, it is possible to precisely determine whether or not electricity theft occurs by monitoring whether or not the equivalent value of the second admittances (or impedances) corresponds to the first admittance (or first impedance) within a certain error range, even though an error of measuring the amount of electricity measured by the watt-hour meter is considered.

Further, if it is determined that the electricity theft has occurred, the occurrence of the electricity theft is notified to a manager, so that it is possible to allow the manager to take an appropriate countermeasure.

Although the present invention has been described in connection with the preferred embodiments, the embodiments of the present invention are only for illustrative purposes and should not be construed as limiting the scope of the present invention. It will be understood by those skilled in the art that various changes and modifications can be made thereto within the technical spirit and scope defined by the appended claims.

What is claimed is:

1. A system for electric energy management, the system comprising:
a first watt-hour meter installed at an upper place on an electric power line, which is close to a power source, so as to measure an amount of electricity supplied to a load with respect to a position at which the first watt-hour meter is installed and calculate a first admittance based on the measured amount of electricity;
a plurality of second watt-hour meters installed at a lower place on the same electric power line as the first watt-hour meter so as to measure an amount of electricity supplied to a load with respect to a position at which each of the second watt-hour meters is installed and calculates second admittances based on the respective measured amounts of electricity; and
a remote server configured to collect information on the amounts of electricity from the first and second watt-hour meters,
wherein the remote server determines presence of electricity theft based on the information on the calculated admittances or the collected information on the amounts of electricity.

2. The system of claim 1, wherein the remote server collects the information on the admittances by the first and second watt-hour meters, compares the first admittance with the total sum of the second admittances, and determines the presence of electricity theft based on a degree to which the difference between the first admittance and the total sum of the second admittances is deviated from an acceptable range.

3. The system of claim 2, wherein, the remote server notifies a manager of the occurrence of the electricity theft, when it is determined that electricity theft has occurred.

4. The system of claim 1, wherein the admittance is calculated based on information on amounts of electricity measured at the same time.

5. The system of claim 1, wherein the admittance is calculated based on an accumulated value of amounts of electricity.

6. The system of claim 1, wherein the admittance is calculated based on an instantaneous value of amounts of electricity.

7. The system of claim 1, wherein the admittance is calculated based on a mean value of amounts of electricity for a certain period of time.

8. The system of claim 1, wherein the remote server determines the presence of electricity theft based on a mean value of admittances for a certain period of time.

9. The system of claim 1, wherein the remote server determines the presence of electricity theft based on whether or not the difference value between the first admittance and the total sum of the second admittances is a previously set limit value or more.

10. The system of claim 1, wherein the remote server determines the presence of electricity theft based on the fluctuation in the difference value between the first admittance and the total sum of the second admittances.

11. The system of claim 1, wherein the acceptable range is set by the manager.

12. The system of claim 1, wherein the acceptable range includes an error of the amounts of electricity measured by the first and second watt-hour meters.

13. The system of claim 1, wherein the acceptable range includes an error generated due to the amount of electricity lost in electric equipment between the first and second watt-hour meters.

14. The system of claim 1, wherein the remote server periodically determines the presence of the electricity theft at a predetermined time.
